(19) United States
(12) Patent Application Publication
(10) Pub. No.: US 2010/0293962 A1
(43) Pub. Date: Nov. 25, 2010

(54) METHOD FOR CONFIGURING COMBINED HEAT AND POWER SYSTEM

(75) Inventors: Timothy C. Wagner, East Hartford, CT (US); Alexander Chen, Ellington, CT (US); Mark E. Marler, Glastonbury, CT (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/769,150

(22) Filed: Apr. 28, 2010

Related U.S. Application Data
(60) Provisional application No. 61/173,801, filed on Apr. 29, 2009.

(51) Int. Cl. F02C 6/00; F02C 1/00

(52) U.S. Cl. 60/783; 290/2

(57) ABSTRACT

A CHP system can include one or more heat sources generating heat output and producing emissions. The CHP system can further include one or more power converters configured to convert the heat into a useful power output. The power converters can deliver the balance of heat to one or more thermally-activated devices (TADs) configured to convert the heat into a useful thermal (heating and cooling) output. The method for configuring the CHP system can comprise the steps of: representing the useful power output by the power converters as a function of the heat output by the heat sources; representing the useful thermal output by the TADs as a function of the heat output by the heat sources; representing the specific emission output as a function of the heat output by the heat sources; and determining the values of the individual heat source heat output which are sufficient to attain the pre-defined levels for useful power output and useful thermal output, while meeting the regulated specific emission levels.

### CROSS-REFERENCE TO RELATED APPLICATION

Reference is made to and this application claims priority from and the benefit of U.S. Provisional Application Ser. No. 61/173,801, filed Apr. 29, 2009, entitled “METHOD FOR CONFIGURING COMBINED HEAT AND POWER SYSTEM”, which application is incorporated herein in their entirety by reference.

### GOVERNMENT CONTRACT

The disclosure described herein was made during the course of or in the performance of work under U.S. Government Contract No. 4000009518 awarded by the Department of Energy.

### FIELD OF THE DISCLOSURE

This disclosure is related generally to power conversion systems, and more specifically to a method for configuring a combined heat and power system to meet emission regulations.

### BACKGROUND OF THE DISCLOSURE

Combined heat and power (CHP) systems, such as PureComfort® systems available from UTC Power Corp. of South Windsor, Conn., are used to provide facility electricity, heating and cooling for commercial, industrial or residential buildings. A typical CHP system produces heat by combusting fuel, then transforms the heat into mechanical power using, e.g., a turbine, and finally transforms the mechanical power into electrical power using, e.g., a generator. The thermal energy in the exhaust from the turbine is used to provide useful thermal output.

Almost inevitably, the fuel combusting process releases pollutant emissions. The emission regulating standards for CHP systems are becoming increasingly more stringent, regulating certain pollutant emissions at full or part power.

Thus, a need exists to provide means and methods of configuring a CHP system to achieve emission compliance at predetermined useful energy output levels.

### SUMMARY OF THE DISCLOSURE

In one embodiment of the present disclosure, there is provided a method of configuring a combined heat and power (CHP) system to attain a configuration target. The CHP system can include one or more heat source generating heat output and producing emissions. The CHP system can further include one or more power converters designed to convert the heat output into a useful power output. The power converters can deliver the balance of heat to one or more thermally-activated devices (TADs) designed to convert the heat into a useful thermal (heating and cooling) output. The method for configuring the CHP system can comprise the steps of: representing the useful power output by the power converters as a function of the heat output by the heat sources; representing the useful thermal output by the thermally-activated devices as a second function of the heat output by the heat sources; representing the emission output as a third function of the heat output by the heat sources; and determining the heat output of individual heat sources at pre-defined levels for useful power output and useful thermal output, to meet the required emission output levels.

In one aspect, the CHP system can include a plurality of heat sources, and the total heat output by the heat sources can be determined as a sum of heat outputs generated by the plurality of the heat sources.

In another aspect, the useful thermal output can include useful heating thermal output and useful cooling thermal output.

In another aspect, the emission output or specific emission output can be measured by a ratio of mass of emission to the useful energy output which includes useful power output and useful thermal output.

In another aspect, the heat sources can be designed to produce the heat output by oxidizing a fuel.

In another aspect, the useful power output can includes a useful electrical energy output, or a useful mechanical energy output.

In another aspect, the CHP system can include a plurality of heat sources, and at least one power converter can be configured to convert into a useful power output at least a portion of the heat output produced by two or more heat sources of the plurality of the heat sources.

In another aspect, the CHP system can include a plurality of power converters, and at least two power converters of the plurality of power converters can be configured to convert into a useful power output at least a portion of the heat source heat output.

In another aspect, the CHP system can include a plurality of power converters, and at least one TAD can be configured to convert into a useful thermal output at least a portion of the power converter heat output.

In another aspect, the CHP system can include a plurality of TADs, and at least two TADs of the plurality of TADs can be configured to convert into a useful thermal output at least a portion of the power converter heat output.

In another aspect, the useful power output by a power converter can be determined by multiplying the power source heat output by the power converter efficiency.

In another aspect, the power converter efficiency can be measured as a ratio of the useful power output to the heat source output, and wherein the power converter heat output can be determined by multiplying the heat source output by a difference between one and the power converter efficiency.

In another aspect, the useful thermal output can be determined by multiplying the power converter heat output by a TAD efficiency.

In another aspect, the emission output can include one or more regulated emissions. For each emission, the emission output can be limited by one or more pre-defined emission levels at one or more pre-defined power levels of the CHP system.

In another aspect, the emission output can include one or more regulated emissions. For each emission, the emission output can be limited by one pre-defined emission level weighted at pre-defined power levels of the CHP system.

### BRIEF DESCRIPTION OF THE DRAWINGS

FIG. 1 illustrates a layout of one embodiment of a combined heat and power (CHP) system according to the present invention.

FIG. 2 illustrates a flowchart of one embodiment of a method of configuring a CHP system according to the present invention.

The drawings are not necessarily to scale, emphasis instead generally being placed upon illustrating the principles of the present invention. In the drawings, like numerals are used to indicate like parts throughout the various views.

### DETAILED DESCRIPTION OF THE DISCLOSURE

There is a combined heat a power (CHP) system combusting fuel and producing useful power output, as well as useful heating and/or cooling energy output. In one embodiment, the CHP system can be configured to produce at least a pre-defined amount of the useful power (e.g., mechanical energy or electrical energy), and at least pre-defined amounts of heating and cooling energy.

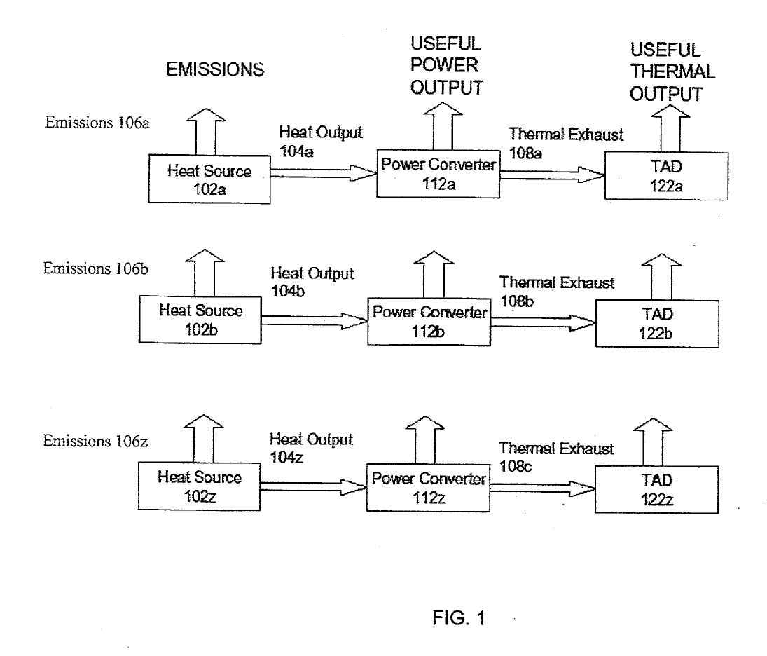

The CHP system can, in one embodiment, include, as best viewed in FIG. 1, one or more heat sources 102a-102z, one or more power converters 112a-112z, and one or more thermally activated devices (TADs) 122a-122z.

In each of heat sources 102-102z, one or more heat outputs 104a-104z can be generated by, e.g., reacting a fuel with an oxidizer. The heat outputs 104a-104z can be delivered to one or more power converters 112a-112z. Each of power converters 112a-112z can produce a useful power output, e.g., mechanical energy or electrical energy. Efficiency of each power converter can be expressed by respective power converter efficiency which, in one embodiment, can be functions of the power converter power output Pᵢ and its characteristic temperature Tpcᵢ:

ηpc₁(P₁, Tpc₁), ηpc₂(P₂, Tpc₂), . . . , ηpcₙ(Pₙ, Tpcₙ)

wherein ηpcᵢ(Pᵢ, Tpcᵢ) denotes the efficiency of i-th power converter as a function of its useful power output Pᵢ and its characteristic temperature Tpcᵢ, i=1, . . . , n; and

n denotes the total number of power converters in the CHP system.

Thus, the total useful power output by the CHP system can be determined as follows:

$$\begin{matrix}{P}_{i} = {Q}_{i} * η {pc}_{i} ( {P}_{i} , {Tpc}_{i} ) & ( 1 ) \\ {P}_{o} = {\sum }_{i = 1}^{n} {P}_{i} & ( 2 )\end{matrix}$$

wherein Pₒ denotes total useful power output by the CHP system;
Pi denotes useful power output by the i-th power converter;
Qᵢ denotes the heat output from the i-th heat source; and
n denotes the total number of power converters in the CHP system.

While the number of power converters, the number of heat sources and the number of TADs have been assumed to be equal for the purposes of streamlining the mathematical expressions, a skilled artisan would appreciate the fact that embodiments where the number of power converters differs from the number of heat sources and/or from the number of TADs are within the scope and the spirit of the present invention. If the number of heat sources 102a-102z in any horizontal chain in FIG. 1 is greater than one, all the heat sources in that horizontal chain can be treated as one heat source whose total heat output is equal to the sum of the individual heat sources' heat outputs in that horizontal chain, and whose total emissions are equal to the sum of the individual heat sources' emissions in that horizontal chain. If in any horizontal chain in FIG. 1 there is no power converter or TAD, a fictitious zero efficiency power converter or TAD can be inserted into that horizontal chain. If in any horizontal chain in FIG. 1 there are more than one power converters or TADs connected in series or in parallel, they can be treated as one power converter or one TAD with their efficiencies effectively combined. The combined effective efficiency of two or more power converters equals to a ratio of the sum of all power output from individual power converters to the heat source output. The combined effective efficiency of two or more TADs equals to a ratio of the sum of all useful thermal output from individual TADs to the power converter heat output. The heat output from two or more power converters connected in parallel is equal to the sum of the individual heat outputs of the power converters. The heat output from two or more power converters connected in series is equal to the heat output of the last power converter in the series.

The calculation of Pi can be iterative, since in equation (1) the efficiency can be a function of Pi.

The balance of heat received by each of power converters 112a-112z from one or more heat sources 102a-102z which was not converted to a useful power, can be delivered to one or more TADs 122a-122z. Each of TADs can generate a useful heating or cooling thermal output or both. Efficiency of each TAD can be expressed by respective TAD efficiency which, in one embodiment, can be functions of the useful thermal output Qtᵢ and characteristic temperature Ttadᵢ:

ηtad₁(Qt₁, Ttad₁), ηtad₂(Qt₂, Ttad₂), . . . , ηtadₙ(Qtₙ, Ttadₙ)

wherein ηtadᵢ(Qₜᵢ, Ttadᵢ) denotes the efficiency of i-th TAD as a function of its useful thermal energy output Qₜᵢ and its characteristic temperature Ttadᵢ, i=1, . . . , n; and

n denotes the total number of TADs in the CHP system.

Thus, the useful thermal energy output by the CHP system can be determined as follows:

Qtᵢ=Qᵢ*(1−ηpcᵢ(Pᵢ, Tpcᵢ))*ηtadᵢ(Qtᵢ, Ttadᵢ) (3)

Wherein Qtᵢ denotes the useful thermal energy output by the i-th TAD. The calculation of Qtᵢ can be iterative, since in equation (3) the TAD efficiency can be a function of Qtᵢ.

In one embodiment, total useful thermal energy output by the CHP system can be equal to a sum of heating thermal energy output and cooling thermal energy output by the CHP system.

The fuel oxidizing reaction in a heat source can create emissions 106a-106z. The emissions can be measured as specific emissions determined as mass of emissions per unit of a useful energy output, e.g., in pounds per megawatt of useful energy output, e.g., to satisfy the applicable regulations. The useful energy output can include the power output, the thermal output or both depending on the regulations. In one embodiment, there can be one or more types of emissions which can be regulated, e.g., by prescribing a maximum amount of a particular type of specific emissions. Assuming that there are q types of regulated specific emissions, a condition prescribing a maximum amount of each type of regulated specific emissions can be expressed as follows:

Emisspcₖ≦EmisspcReqₖ (4)

wherein Emisspcₖ denotes the amount of k-th type of specific emissions produced by the CHP system;

EmisspcReqₖ denotes the maximal allowed amount of k-th type of specific emissions by regulations, k=1, . . . , q; and

q denotes the total number of types of regulated emissions.

In one embodiment, the amount of each type of specific emissions released by a CHP system, can be determined as follows:

$${Emisspc}_{k} = ( {\sum }_{i = 1}^{n} {Emishs}_{ik} ( {Q}_{i} , {Ths}_{i} ) ) / ( {\sum }_{i = 1}^{n} ( {P}_{i} + {Qt}_{i} ) ) \qquad ( 5 )$$

wherein Emishsᵢₖ(Qᵢ, Thsᵢ) denotes the mass emission of k-th type of emission released by i-th heat source of a CHP system as a function of the heat source heat output Qᵢ and characteristic temperature Thsᵢ;

Qtᵢ denotes the useful thermal energy output by the i-th TAD; and

q denotes the total number of types of regulated specific emissions.

In one embodiment, the CHP system can be configured to satisfy the specific emissions limitations (4) at total specific useful power output and useful thermal energy output levels:

$$\begin{matrix}{P}_{o} = {P}_{D} & ( 6 ) \\ {Q}_{to} = {\sum }_{i = 1}^{n} ( {Qt}_{i} ) \text{)} = {Q}_{D} & ( 7 )\end{matrix}$$

wherein P_{D} denotes a predetermined value for the total power output by the CHP system,

Qto denotes the useful thermal energy output by the CHP system; and

Q_{D} denotes a predetermined value for the total useful thermal energy output by the CHP system.

Thus, the CHP system can be configured to satisfy the conditions (4), (6), and (7). The equations (1), (2), (3), and (5) can be used to calculate the amount of specific emissions Emisspcₖ to be substituted in the condition (4).

In another embodiment, the emissions can be regulated by prescribing a maximum amount of a particular type of specific emissions at several system power levels, rather than at full system power. Assuming that there are q types of regulated specific emissions, a condition prescribing a maximum amount of each type of regulated specific emissions at each of the p power levels can be expressed as follows:

Emisspcₖⱼ≦EmisspeReqₖⱼ (4′)

wherein Emisspcₖⱼ denotes the amount of k-th type of specific emissions when the CHP system is at the j-th power level;

EmisspcReqₖⱼ denotes the maximal prescribed amount of k-th type of specific emissions when the CHP system is at the j-th power level, k=1, . . . , q; j=1, . . . , p;

q denotes the total number of types of regulated specific emissions; and

p denotes the total number of system power levels specified by regulations.

In this embodiment, the amount of each type of specific emissions released by a CHP system, can be determined as follows:

$${Emisspc}_{kj} = ( {\sum }_{i = 1}^{n} {Emishs}_{ikj} ( {Q}_{ij} , {Ths}_{ij} ) ) / ( {\sum }_{i = 1}^{n} ( {P}_{ij} + {Qt}_{ij} ) ) \qquad ( 5 ’ )$$

wherein Emishsᵢₖⱼ(Qᵢⱼ, Thsᵢⱼ) denotes the mass emission of k-th type of emission released by i-th heat source of a CHP system at the j-th power level as a function of the heat source heat output Qᵢⱼ and characteristic temperature Thsᵢⱼ;

Qtᵢⱼ denotes the useful thermal energy output by the i-th TAD when the CHP system is at the j-th power level; and

Ptᵢⱼ denotes the useful power output by the i-th power converter when the CHP system is at the j-th power level; and

Thsᵢⱼ denotes the characteristic temperature of the i-th heat source when the CHP system is at the j-th power level; and

q denotes the total number of types of regulated specific emissions.

In this embodiment, the equivalent form of equation (1) and (2) are

$$\begin{matrix}{P}_{ij} = {Q}_{ij} * η {pc}_{ij} ( {P}_{ij} , {Tpc}_{ij} ) & ( 1 ’ ) \\ {Po}_{j} = {\sum }_{i = 1}^{n} {P}_{ij} & ( 2 ’ )\end{matrix}$$

wherein Pₒⱼ denotes the useful power output by the CHP system when the CHP system is at the j-th power level; j=1, . . . , p; p denotes the total number of system power levels specified by regulations; and

Pij denotes useful power output by the i-th power converter when the CHP system is at the j-th power level; and

Qᵢⱼ denotes the heat output from the i-th heat source when the CHP system is at the j-th power level; and

ηpcᵢⱼ(Pᵢⱼ, Tpcᵢⱼ) denotes the efficiency of the i-th power converter when the CHP system is at the j-th power level; and

Tpcᵢⱼ denotes the characteristic temperature of the i-th power converter when the CHP system is at the j-th power level; and

n denotes the total number of power converters in the CHP system.

The calculation of Pij can be iterative, since in equation (1′) the efficiency can be a function of Pij.

In this embodiment, the equivalent form of equation (3) is

Qtᵢⱼ=Qᵢⱼ*(1−ηpcᵢⱼ(Pᵢⱼ, Tpcᵢⱼ))*ηtadᵢⱼ(Qtᵢⱼ, Ttadᵢⱼ) (3′)

wherein Qtᵢⱼ denotes the useful thermal energy output by the i-th TAD when the CHP system is at the j-th power level. The calculation of Qtᵢⱼ can be iterative, since in equation (3′) the TAD efficiency can be a function of Qtᵢⱼ, and

Qᵢⱼ denotes the heat source output by the i-th heat source when the CHP system is at the j-th power level; and

Qtᵢⱼ denotes the useful thermal energy output by the i-th TAD when the CHP system is at the j-th power level; and

ηpcᵢⱼ(Pᵢⱼ, Tpcᵢⱼ) denotes the efficiency of the i-th power converter when the CHP system is at the j-th power level; and

Tpcᵢⱼ denotes the characteristic temperature of the i-th power converter when the CHP system is at the j-th power level; and

ηtadᵢⱼ(Qtᵢⱼ, Ttadᵢⱼ) denotes the efficiency of the i-th power converter when the CHP system is at the j-th power level; and

Ttadᵢⱼ denotes the characteristic temperature of the i-th TAD when the CHP system is at the j-th power level.

In this embodiment, the equivalent form of equation (6), (7) are

$$\begin{matrix}{Po}_{j} = {P}_{Dj} & ( 6 ’ ) \\ {Qto}_{j} = {\sum }_{i = 1}^{n} ( {Qt}_{ij} ) \text{)} = {Q}_{Dj} & ( 7 ’ )\end{matrix}$$

wherein P_{Dj} denotes the pre-defined value by regulations for the power output by the CHP system when the CHP system is at the j-th power level; j=1, . . . , p; p denotes the total number of system power levels specified by regulations; and

Q_{Dj} denotes the pre-defined value by regulations for the useful thermal energy output by the CHP system when the CHP system is at the j-th power level;

Qtoⱼ denotes the useful thermal energy output by the CHP system when the CHP system is at the j-th power level.

In accordance with this embodiment, the CHP system can be configured by selecting the Qᵢⱼ based on emission characteristics of each heat sources to satisfy the conditions (4′), (6′), and (7′). The equations (1′), (2′), (3′), and (5′) can be used to calculate the specific emissions Emisspcₖⱼ to be used in the condition (4′).

In another embodiment, the emissions can be regulated by prescribing a weighted average amount at several system power levels for a particular type of specific emissions. Assuming that there are q types of regulated specific emissions, a condition prescribing a weighted average amount of each type of regulated specific emissions can be expressed as follows:

Emisspcwₖ≦EmisspcwReqₖ (4″)

wherein Emisspcwₖ denotes the weighted average amount at several system power levels for k-th type of specific emissions;

EmisspcwReqₖ denotes the maximal prescribed weighted average amount at several system power levels for k-th type of specific emissions, k=1, . . . , q;

q denotes the total number of types of regulated specific emissions; and

p denotes the total number of system power levels for weighing specified by regulations.

n denotes the total number of heat sources in the CHP system;

In this embodiment, the amount of each type of weighted average specific emissions released by a CHP system, can be determined as follows:

$${Emisspcw}_{k} = {\sum }_{j = 1}^{p} {A}_{kj} ( {\sum }_{i = 1}^{n} {Emishs}_{ikj} ( {Q}_{ij} , {Ths}_{ij} ) ) / ( {\sum }_{i = 1}^{n} ( {P}_{ij} + {Qt}_{ij} ) ) \qquad ( 5 ’ ’ )$$

wherein Emishsᵢₖⱼ(Qᵢⱼ, Thsᵢⱼ) denotes the mass emission of k-th type of emission released by i-th heat source of a CHP system at the j-th power level as a function of the heat source heat output and characteristic temperature Thsᵢⱼ; and

Qtᵢⱼ denotes the useful thermal energy output by the i-th TAD when the CHP system is at the j-th power level; and

q denotes the total number of types of regulated specific emissions; and

Aₖⱼ denotes a weight factor for the k-th emission type at the j-th CHP system power level; and

Qᵢⱼ denotes the amount of heat produced by the i-th heat source at the j-th CHP system power level; and

Thsᵢⱼ denotes the characteristic temperature for the i-th heat source at the j-th CHP system power level; and

Pᵢⱼ denotes the power output for the i-th power converter at the j-th CHP system power level.

In accordance with this embodiment, the CHP system can be configured by selecting the to satisfy the conditions (4″), (6′), and (7′). The equations (1′), (2′), (3′), and (5″) can be used to calculate the specific emissions Emisspcwₖ to be used in the condition (4″).

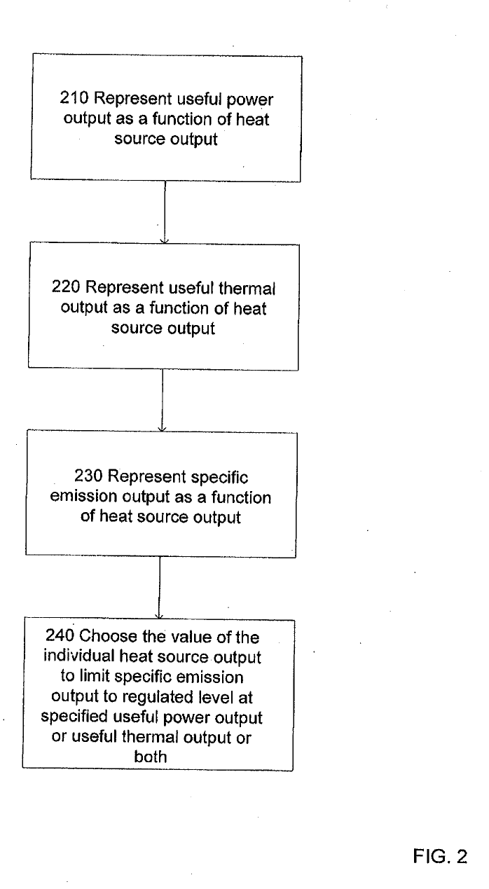

A method of configuring a CHP system to attain a configuration target is now being described with references to FIG. 2. In one embodiment of the method, the CHP system can include one or more heat sources generating heat output and producing emissions. The CHP system can further include one or more power converters designed to convert the heat into a useful power output. The power converters can deliver the balance of heat to one or more TADs designed to convert the heat into a useful thermal (heating and cooling) output.

The configuration target is represented by a specific emission level.

At step 210, the useful power output by the power converters can be represented as a function of the power source heat output. In one embodiment, the useful power source heat output can be represented by the equations (1) and (2) described herein supra.

At step 220, the useful thermal output by the TAD can be represented as a function of the power converter heat output. In one embodiment, the useful thermal output can be represented by the equation (2) described herein supra.

At step 230, the specific emission output can be represented as a function of heat source heat output. In one embodiment, the specific emission output can be represented by the equation (5) described herein supra. In another embodiment, the specific emission output can be represented by the equation (5′) described herein supra. In yet another embodiment, the specific emission output can be represented by the equation (5″) described herein supra.

At step 240, choose the values of the individual heat source heat output which are sufficient to attain the pre-defined levels for useful power output, or useful thermal output or both, while meeting the regulated specific emission levels. In the above examples, both pre-defined levels for useful power output and useful thermal output are assumed to be prescribed by pertinent regulations. Alternatively, only useful power output is prescribed, in which situation equations (7) and (7′) are not applicable, or only useful thermal output is prescribed, in which situation equations (6) and (6′) are not applicable.

In one embodiment, the values of the individual heat source heat output can be determined using the equations (1), (2), (3), and (5) to satisfy the conditions (4), (6), and (7) described herein supra. In another embodiment, the values of the individual heat source heat output can be determined using the equations (1′), (2′), (3′), and (5′) to satisfy the conditions (4′), (6′), and (7′) described herein supra. In another embodiment, the values of the individual heat source heat output can be determined using the equations (1′), (2′), (3′), and (5″) to satisfy the conditions (4″), (6′), and (7′) described herein supra.

Upon completing the calculation, the method can terminate.

While the present invention has been particularly shown and described with reference to certain exemplary embodiments, it will be understood by a skilled artisan that various changes in detail can be affected therein without departing from the spirit and scope of the invention as defined by claims that can be supported by the written description and drawings. Further, where exemplary embodiments are described with reference to a certain number of elements it will be understood that the exemplary embodiments can be practiced utilizing less than the certain number of elements.

We claim:

1. A method of configuring a combined heat and power (CHP) system to attain a configuration target, said system including at least one heat source configured to generate a first heat output, said heat source producing an emission output, at least one power converter configured to convert at least a first portion of said first heat output into a useful power output, said power converter outputting a second heat output, and at least one thermally-activated device (TAD) configured to convert at least a second portion of said second heat output into a useful thermal output, said configuration target determined by attaining a pre-defined demand level for at least one of: said useful power output, said useful thermal output, said method comprising the steps of:
representing at least one of: said useful power output, said useful thermal output as a first function of said first heat output;
representing said emission output as a second function of said first heat output;
determining a value of said first heat output which is sufficient to attain said control target, while providing one of: limiting said emission output by a pre-defined emission level, minimizing said emission output.

2. The method of claim 1, wherein said at least one heat source is provided by a plurality of heat sources; and
wherein said first heat output is determined as a sum of first heat outputs generated by said plurality of said heat sources.

3. The method of claim 1, wherein said useful thermal output includes at least one of useful heating thermal output, useful cooling thermal output.

4. The method of claim 1, wherein said emission output is measured by a specific mass of emissions to a unit of a useful energy output.

5. The method of claim 1, wherein said heat source is configured to produce said heat output by oxidizing a fuel.

6. The method of claim 1, wherein said useful power output includes at least one of: a useful electrical power output, a useful mechanical power output.

7. The method of claim 1, wherein said at least one heat source is provided by a plurality of heat sources; and
wherein at least one power converter is configured to convert into a useful power output at least a first portion of said first heat output produced by two or more heat sources of said plurality of said heat sources.

8. The method of claim 1, wherein said at least one power converter is provided by a plurality of power converters; and
wherein at least two power converters of said plurality of power converters are configured to convert into a useful power output at least a first portion of said first heat output.

9. The method of claim 1, wherein said at least one power converter is provided by a plurality of power converters; and
wherein at least one TAD is configured to convert into a useful thermal output at least a second portion of said second heat output outputted by two or more power converters of said plurality of power converters.

10. The method of claim 1, wherein said at least one TAD is provided by a plurality of TADs; and
wherein at least two TADs of said plurality of TADs are configured to convert into a useful thermal output at least a second portion of said second heat output.

11. The method of claim 1, wherein said at least one power converter has a power converter efficiency; and
wherein said useful power output is determined by multiplying said first heat output by said power converter efficiency.

12. The method of claim 1, wherein said at least one power converter has a power converter efficiency measured as a ratio of said useful power output to said first heat output; and
wherein said second heat output is determined by multiplying said first heat output by a difference between one and said power converter efficiency.

13. The method of claim 1, wherein said TAD has a TAD efficiency; and
wherein said useful thermal output is determined by multiplying said second heat output by said TAD efficiency.

14. The method of claim 1, wherein said emission output includes one or more regulated emissions;
wherein said pre-defined emission level includes one or more regulated emission levels; and
wherein each of said regulated emissions is determined by multiplying a pre-defined regulated emission coefficient by said first heat output.

15. The method of claim 1, wherein said emission output includes one or more regulated emissions;
wherein said pre-defined emission level includes one or more regulated emission levels;
wherein each of said one or more regulated emission levels includes at least one regulated emission level defined at a given system power level; and
wherein each of said regulated emissions is determined by multiplying a pre-defined regulated emission coefficient by said first heat output at said given system power level.
